(19) United States
(12) Patent Application Publication
(10) Pub. No.: US 2024/0058880 A1
(43) Pub. Date: Feb. 22, 2024

(54) TOOL CHANGER

(71) Applicant: Reishauer AG, Wallisellen (CH)

(72) Inventors: Michel MÜLLER, Uster (CH); Erwin SENNHAUSER, Kleinandelfingen (CH); Oliver FELLMANN, Binz (CH); Pirmin Eric KREIER, Wallisellen (CH)

(73) Assignee: Reishauer AG, Wallisellen (CH)

(21) Appl. No.: 18/265,858

(22) PCT Filed: Nov. 29, 2021
(86) PCT No.: PCT/EP2021/083316

§ 371 Date: Jun. 7, 2023

(30) Foreign Application Priority Data
Dec. 8, 2020 (CH) 01556/20

(51) Int. Cl. B23F 23/12; B23Q 11/08; B23Q 3/155

(52) U.S. Cl. CPC B23F 23/1206; B23F 23/1243; B23Q 11/0891; B23Q 3/15536; B23Q 3/1554; B23Q 2003/155439; B23Q 2003/155442; B23Q 2003/155428; B23B 2270/36

(57) ABSTRACT

A tool changer is used for changing tools in a machine tool. The tool changer has a support structure on which a lifting carriage is guided along a vertical lifting direction. A pivot arm is pivotably mounted to the lifting carriage about a vertical pivot axis. A plurality of tool holders arranged vertically one above the other form a tool magazine. A tool gripper is attached to the pivot arm. The tool gripper grips a tool. The tool is subsequently moved between one of the tool holders and the tool spindle of the machine tool by a combined lifting and pivoting movement of the pivot arm. Optionally, an auxiliary arm pivotably attached to the pivot arm can be used to change a workpiece clamping means of the machine tool.

### TECHNICAL FIELD

The present invention relates to a tool changer for a machine tool, a machine tool equipped therewith and the use of such a tool changer. The machine tool may be a gear cutting machine, in particular for gear generating machining. The tool to be changed may in particular be a gear skiving tool.

### PRIOR ART

In machine tools, it is often necessary to replace one tool with another, for example to re-sharpen a worn tool. This also applies in particular to gear cutting machines. For example, gear skiving tools have a limited service life and must therefore be replaced regularly. In order to reduce the effort and time required for tool changes, automatic tool changers have been proposed in the state of the art.

For example, US20170232564A1 discloses a tool changer on a hobbing machine. During tool changing, the tool in the form of a hob cutter is removed from the tool head of the hobbing machine and picked up by a suspension device. The suspension device is transported to an intermediate position by means of a horizontal transport rail and there rotated about a vertical axis into a removal position so that the hob cutter can be removed. Due to its design, this tool changer is only suitable for machines whose tool rotation axis is horizontal and only for tools that are mounted on both sides in the tool head. The tool changer is in particular not suitable for gear skiving tools. It also takes up a lot of space.

US2014106950A1 discloses a tool changer with a gripper mounted on a carriage unit with three carriages. Milling tools are suspended vertically in a rotation magazine. The rotation in the rotation magazine takes place in a horizontal plane. The milling tools can be transported back and forth between the rotation magazine and a machining head with the tool changer. Due to its design, this tool changer is also only suitable for tools that are mounted on both sides in the tool head, and is therefore unsuitable for gear skiving tools. In addition, this tool changer also requires a lot of space.

US2019070682A1 discloses a tool changer that transports gear skiving tools back and forth between a rotation magazine and a machining head by means of a horizontal carriage.

Here, the circulation of the circulation magazine takes place in a vertical plane. This tool changer also requires a relatively large amount of space.

US2020130120A1 discloses a tool changer that can also be used to change gear skiving tools. The tools are stored in a drum-shaped tool magazine. The tool changer has a double arm which can be pivoted about a horizontal axis. A gripping section is formed at each of the free ends of the double arm. The double arm grips with the gripping sections both a machining tool which is clamped on the tool spindle and a tool which has been ejected from the tool magazine, and exchanges these two tools for each other. This tool changer also takes up a relatively large amount of space.

WO2012027770A2 discloses a tool magazine in which a plurality of bending tools are stored in tool holders arranged one above the other. An articulated arm robot removes the tools from the magazine and transfers them to a bending machine. Use on a gear cutting machine is not disclosed.

US2010173762A1 discloses a tool changer with a raisable and lowerable as well as rotatable support column to which a double gripper is attached. The tool changer transports tools between a tool spindle and a chain magazine in which the tools are suspended. The tool changer has a complex cam mechanism to generate the lifting and rotating movements.

The design of the tool changer is relatively complex. Use on a gear cutting machine is also not disclosed here.

### SUMMARY OF THE INVENTION

It is an object of the present invention to disclose a tool changer which, due to its construction, can be configured to be particularly space-saving.

This object is achieved by a tool changer according to claim 1. Further embodiments are laid down in the dependent claims.

A tool changer for changing tools in a machine tool, in particular a gear cutting machine, is disclosed. The tool changer comprises:
a support structure;
a lifting carriage which is guided on the support structure along a lifting direction running vertically in space;
a pivot arm which is pivotably mounted to the lifting carriage so that it is pivotable about a pivot axis extending vertically in space;
a tool gripper mounted on the pivot arm and configured to grip a tool; and
a tool magazine with a plurality of tool holders arranged vertically one above the other,
wherein the tool changer is configured to move a tool gripped by the tool gripper by a combined lifting and pivoting movement of the pivot arm selectively between one of the tool holders and a tool spindle of the machine tool or between two different tool holders of the tool magazine.

Since the tool magazine is being formed by several tool holders arranged vertically one above the other, a very small space requirement for the tool magazine results. Such a tool magazine can be loaded and unloaded very easily. For this purpose, the invention proposes a vertically movable lifting carriage to which a horizontally pivotable pivot arm with tool gripper is pivotably mounted. Such an arrangement can be implemented simply and inexpensively and also requires very little space. All in all, the result is a very compact tool changer that can be easily integrated directly into the machine tool by connecting the support structure to the machine bed of the machine tool.

In particular, the support structure may comprise a vertical column configured to be mounted at a lower end to a machine bed of the machine tool. The lifting carriage is then guided along the lifting direction on the column. Preferably, the tool holders are also mounted to this column. However, in alternative embodiments, it is also conceivable to attach the tool holders to another element of the support structure.

In order to enable a particularly simple loading of the tool magazine, one of the tool holders of the tool magazine may be movably mounted to the support structure, in particular displaceably along a horizontal loading direction and/or pivotably about a vertical loading pivot axis. In particular, the tool changer may comprise an outer wall separating an interior space of the tool changer from an exterior space. The outer wall may then comprise a tool loading opening for exchanging tools between the interior space and the exterior space. It is then of particular advantage if the movable tool holder is movable through the tool loading opening to make the movable tool holder accessible from the exterior space. The remaining tool holders may be stationarily connected to the support structure.

The tool changer may comprise a tool loading door configured to selectively close or open the tool loading opening. The tool loading door may comprise a status indicator to report the opening status of the tool loading opening (open or closed) to a control device. The control device may be configured to prevent movements in the interior of the tool changer as long as the tool loading opening is open, and/or to prevent opening of the tool loading door as long as movements are performed in the interior of the tool changer.

In preferred embodiments, the movable tool changer is implemented as follows: The tool changer has a loading linear guide and a loading carriage guided by the loading linear guide so as to be displaceable along the horizontal loading direction. The movable tool holder is then mounted on the loading carriage so as to be pivotable about the vertical loading pivot axis. This combination of linear displaceability and pivotability of the movable tool holder results in particularly good accessibility of this tool holder with minimal space requirements.

Preferably, the tool changer further comprises a bulkhead configured to separate the interior space of the tool changer from a machining space of the machine tool. The bulkhead then comprises a bulkhead opening, and the tool changer comprises a bulkhead door which is configured to selectively close or open the bulkhead opening. For this purpose, the bulkhead door may comprise a corresponding drive, for example a pneumatic drive. The bulkhead opening is sufficiently high so that the pivot arm with the tool gripper mounted thereto can be moved through the open bulkhead opening in at least one position of the lifting carriage, preferably in a certain range of positions of the lifting carriage. Preferably, the bulkhead opening is also sufficiently high that the lifting carriage can be moved along the lifting direction by a certain amount when the pivot arm extends through the bulkhead opening. In this way, the tool change and optional clamping means change and/or workpiece change, described in more detail below, are facilitated.

The tool changer can further comprise a reading station, wherein the reading station is arranged in such a way that a tool held by the tool gripper can be moved to the reading station by a combined lifting and pivoting movement of the pivot arm to read a machine-readable data carrier on the tool. For example, the data carrier may be an RFID transponder. Accordingly, the reading station may be an RFID station having an RFID transceiver. In other embodiments, the data carrier may be an optical data carrier, for example a barcode or a QR code, and the reading station may then be configured to optically read such an optical data carrier. For this purpose, the reading station may comprise a corresponding reading device comprising an optical sensor, e.g. a camera, and optionally a light source, e.g. an LED light source. A magnetic data carrier or a tactile readable data carrier are also conceivable.

In order to avoid damage to the reading station, the reading station may be of a spring-loaded design. For this purpose, the reading station may comprise a base, the aforementioned reading device and a spring element arranged therebetween in such a way that the reading device can be moved vertically downwards relative to the base against a restoring force generated by the spring element. This prevents damage to the reading device or the corresponding data carrier when the tool is placed on the reading station. This is particularly advantageous when tools of different lengths are used and the length of the respective tool is not known in advance. By making the reading station spring-loaded, the lifting carriage can always be moved to the same position for reading the tool, regardless of the length of the tool. The different lengths of the tools are then compensated by the spring element.

The tool changer may further comprise a tool cleaner. The latter is preferably arranged in such a way that a tool held by the tool gripper is movable towards the tool cleaner by a combined lifting and pivoting movement of the pivot arm, in order to clean a tool support of the tool. In particular, the tool cleaner may be arranged on the support structure, in particular above the tool holders. If the support structure is formed as a column, the tool cleaner may be arranged at an upper end of the column.

To reduce unproductive idle time, the tool gripper can be configured as a multiple gripper having at least two pairs of gripper jaws so that it can grip two or more tools.

The tool gripper may be rigidly or movably mounted to the pivot arm. In particular, the tool gripper can be mounted on the pivot arm so as to be pivotable, for example pivotable about a vertical or horizontal gripper pivot axis, and/or displaceable, in particular linearly displaceable along a horizontal gripper displacement direction.

Objects other than tools may also be gripped by the tool gripper in order to perform additional functions with these objects. For example, the tool changer may comprise a taper cleaner, the taper cleaner being configured to be gripped by the tool gripper. The taper cleaner may be moved by a combined lifting and pivoting movement of the pivot arm towards the tool spindle, in order to clean the taper receptacle thereof. Also, the tool changer may comprise a measuring probe, wherein said measuring probe may be configured, for example, for a radial and axial runout measurement of the workpiece clamping means of the machine tool. The measuring probe may then, in turn, be configured to be grippable by the tool gripper in order to move it into a measuring position by a combined lifting and pivoting movement of the pivot arm. The measuring probe may continue to be held in the measuring position by the tool gripper, or it may be received in the measuring position by another component of the machine tool, for example clamped on the tool spindle.

The tool changer may be configured to change not only tools, but also workpieces. For this purpose, the tool changer may additionally comprise a workpiece gripper mounted to the pivot arm. The workpiece gripper may be moved in the same manner as the tool gripper by combined lifting and pivoting movements of the pivot arm. The workpiece gripper can then be configured to pick up workpieces from a workpiece rest and transfer them to a workpiece spindle of the machine tool.

In order to generate the combined lifting and pivoting movement of the pivot arm, the tool changer may comprise a lifting carriage drive for driving the lifting carriage to perform a lifting movement along the lifting direction, and a pivot drive for driving the pivot arm to perform a pivoting movement relative to the lifting carriage about the pivoting axis. Furthermore, the tool changer may comprise a control device configured to control the lifting carriage drive, the pivot drive and the gripper and optionally other components of the tool changer. The control device may be an integrated part of the machine control of the machine tool; however, it is also conceivable to provide an independent control device which only controls the components of the tool changer and communicates with the actual machine control. The control device may in particular comprise a suitably programmed control computer. The latter may interact with suitable NC axis modules for the individual drives.

In particular, the control device may be configured to control at least one of the following operations:
a) gripping a tool with the tool gripper;
b) moving a tool gripped by the tool gripper between one of the tool holders and a tool spindle of the machine tool by a combined lifting and pivoting movement of the pivot arm;
c) moving a tool gripped by the tool gripper between two different tool holders of the tool magazine by a combined lifting and pivoting movement of the pivot arm;
(d) opening and closing the bulkhead door; and
e) moving a tool gripped by the tool gripper to the reading station by a combined lifting and pivoting movement of the pivot arm and reading a data carrier on the gripped tool;
f) moving a tool gripped by the tool gripper to the tool cleaner by a combined lifting and pivoting motion of the pivot arm and cleaning a tool support of the gripped tool with the tool cleaner;
(g) moving the tool gripper relative to the pivot arm; and
h) moving a taper cleaner gripped by the tool gripper to the tool spindle by a combined lifting and pivoting movement of the pivot arm;
j) moving a measuring probe gripped by the tool gripper to a measuring position by a combined lifting and pivoting movement of the pivot arm;
k) gripping a workpiece with the workpiece gripper and moving a workpiece gripped by the workpiece gripper between a workpiece rest and a workpiece spindle of the machine tool by a combined lifting and pivoting motion of the pivot arm.

In this respect, the present invention also discloses a method of operating a tool changer of the aforementioned type, the method comprising performing at least one of the aforementioned operations a) to k).

In preferred embodiments, the tool changer not only serves to change tools, but can also be used to change a clamping means for the workpieces. For this purpose, the tool changer has an auxiliary arm which mounted to the pivot arm so as to be pivotable about a vertically extending auxiliary pivot axis in such a way that the auxiliary pivot axis of the auxiliary arm and the pivot axis of the pivot arm are parallel and spaced apart from one another. Preferably, the auxiliary arm is releasably lockable to the pivot arm in a rest position to prevent a pivoting movement of the auxiliary arm about the auxiliary pivot axis. The auxiliary arm is configured to have a workpiece clamping means of the machine tool attached thereto.

For this purpose, the auxiliary arm may, for example, have a receptacle for a clamping means holder. This receptacle may, for example, be configured as a bayonet-type connection between the auxiliary arm and the clamping means holder. For this purpose, the receptacle may be annular, with optional recesses on the inner circumference for making the bayonet connection. Accordingly, the workpiece changer may also comprise a clamping means holder configured to be detachably connected to the auxiliary arm and the workpiece clamping means such that the workpiece clamping means is attachable to the auxiliary arm via the clamping means holder. In particular, the workpiece clamping means may be attachable to the auxiliary arm in a suspended manner. This makes it possible to use a particularly simple and light clamping means holder, since the latter is not loaded by torsional or shear forces.

The auxiliary arm makes it particularly easy to change the clamping means for the workpieces. External aids such as on-site cranes, mobile crane trolleys, special set-up trolleys with corresponding additional function, etc. can be dispensed with. This can save considerable costs and the space requirement for external aids is eliminated.

A force transducer may be arranged on the auxiliary arm in order to detect a load on the auxiliary arm in the vertical direction. For example, the receptacle for the clamping means holder can be connected to the auxiliary arm via the force transducer. In this way, an overload of the system of pivot arm and auxiliary arm can be detected.

The present invention also discloses the use of a tool changer of the abovementioned type for changing a workpiece clamping means on a machine tool. A corresponding method comprises at least one, preferably all, of the following steps, these steps not necessarily being carried out in the order indicated:
performing a combined lifting and pivoting movement of the pivot arm and pivoting the auxiliary arm relative to the pivot arm in order to bring the auxiliary arm into a position in which it can be connected to the workpiece clamping means via the clamping means holder;
connecting the clamping means holder with the auxiliary arm and with the workpiece clamping means;
lifting of the workpiece clamping means attached to the auxiliary arm via the clamping means holder by a lifting movement of the lifting carriage;
pivoting the workpiece clamping means attached to the clamping means holder into an exterior space of the machine tool by pivoting the pivot arm; and
putting the workpiece clamping means attached to the clamping means holder on a clamping means rest by a lifting movement of the lifting carriage.

The present invention further relates to a machine tool comprising a tool changer of the type mentioned above. The machine tool may be a gear cutting machine, in particular a gear cutting machine for gear generating machining. The machine tool comprises a machine bed and a tool spindle. The tool spindle is used to drive a tool to rotate about a tool axis. Preferably, the tool spindle is pivotably arranged in the machine tool relative to the machine bed such that it can be brought into a position in which the tool axis extends vertically in space in order to perform a tool change. The tool changer is then arranged on the machine bed in such a way that a tool gripped by the tool gripper is movable from one of the tool holders of the tool magazine to the tool spindle by a combined lifting and pivoting movement of the pivot arm.

In particular, the tool spindle may be movable relative to the machine bed along at least one direction of travel, this direction of travel extending transversely to the lifting direction of the lifting carriage, in order to bring the tool spindle selectively into a position in which a tool gripped on the tool gripper can be clamped on the tool spindle, or into a retracted position in which the tool spindle with a tool clamped thereon is located outside a collision contour of a pivoting movement of the pivot arm. Preferably, this direction of travel is horizontal. Furthermore, the tool spindle may be movable along a direction parallel to the lifting direction of the lifting carriage.

The machine tool preferably further comprises a workpiece spindle with a workpiece clamping means. The workpiece spindle drives the workpiece clamping means to rotate about a workpiece axis. Preferably, the workpiece axis is vertical in space. If the machine tool is a gear cutting machine for gear generating machining, the machine tool has a machine control which establishes a gear coupling between the rotational movements of the tool spindle and the workpiece spindle, i.e. couples these movements in such a way that the corresponding rotational speeds are in a predeterminable fixed ratio and a predeterminable phase relationship to one another.

The workpiece spindle is preferably arranged on the machine bed in such a way that the workpiece clamping means can be attached to the auxiliary arm when the latter is pivoted out of the rest position relative to the pivot arm. For this purpose, the workpiece spindle is preferably movable relative to the machine bed along at least one direction, this direction extending transversely to the lifting direction of the lifting carriage, in order to bring the tool spindle into a position in which the receptacle on the auxiliary arm is arranged vertically above a workpiece clamping means located on the workpiece spindle. Preferably, this direction again extends horizontally. Preferably, it is orthogonal to the horizontal direction along which the tool spindle is horizontally movable.

### BRIEF DESCRIPTION OF THE DRAWINGS

Preferred embodiments of the invention are described below with reference to the drawings, which are for explanatory purposes only and are not to be construed restrictively. The drawings show in each case in a schematic perspective view:

FIG. 1 a machine tool with a tool changer according to a first embodiment of the present invention in a parking position, the machine tool and the tool changer being shown in a highly simplified form for the sake of clarity;

FIG. 2 the tool changer of FIG. 1 alone;

FIG. 3 the tool changer according to FIG. 2, the bulkhead of FIGS. 1 and 2 having been omitted for the sake of clarity;

FIG. 4 the tool changer from another viewpoint, without bulkhead;

FIG. 5 the tool changer in a clamping position, without bulkhead;

FIG. 6 the machine tool of FIG. 1 with the tool changer in the clamping position, without bulkhead;

FIG. 7 the tool changer in a transfer position, without bulkhead;

FIG. 8 the tool changer in a ready position, without bulkhead;

FIG. 9A to FIG. 9D four views of a part of the tool changer illustrating the movement of the tool loading station;

FIG. 10 a tool with tool holder and RFID transponders;

FIG. 11 the tool changer in a gripping position, without bulkhead;

FIG. 12 a section of the machine tool of FIG. 1, with a taper cleaner received in the tool gripper;

FIG. 13 another section of the machine tool of FIG. 1, with a measuring probe accommodated in the tool gripper;

FIG. 14 the tool changer of the first embodiment in a view corresponding to FIG. 3, but with additional components shown which have been omitted in FIGS. 1 to 13 for the sake of clarity;

FIG. 15 a detailed view of FIG. 14 in area XV;

FIG. 16 a section of a tool changer according to a second embodiment;

FIG. 17 a tool changer according to a third embodiment, without bulkhead;

FIG. 18 a section of a tool changer according to a fourth embodiment;

FIG. 19 a section of a tool changer according to a fifth embodiment in a first position;

FIG. 20 a section of the tool changer of the fifth embodiment in a second position;

FIG. 21 the machine tool of FIG. 1 with the tool changer of the first embodiment, wherein the tool changer is in a clamping means change position;

FIG. 22 the tool changer of the first embodiment in the clamping means change position;

FIG. 23 the machine tool of FIG. 21 with the clamping means swung out of the machine; and

FIG. 24 a section of the tool changer of the fourth embodiment with the clamping means pivoted out.

### DESCRIPTION OF PREFERRED EMBODIMENTS

### Definitions

Gear cutting machine: A machine configured to produce or machine gear teeth on workpieces, in particular internal or external gear teeth on gears. For example, it can be a fine machining machine with which pre-toothed workpieces are machined, in particular a hard finishing machine with which pre-toothed workpieces are machined according to a hardening process.

Gear generating machining: A type of gear machining in which a tool rolls on a workpiece, producing a cutting motion. Various gear generating machining processes are known, whereby a distinction is made between processes with a geometrically undefined cutting edge, such as generating gear grinding or gear honing, and processes with a geometrically defined cutting edge, such as gear hobbing, gear skiving, gear shaving or gear shaping.

Gear skiving or hob peeling: The gear skiving process is a continuous chip-removing process for the production of axially symmetrical periodic structures, in which gear-shaped tools are used. A gear skiving tool (“skiving wheel”) has a large number of cutting edges on its face. The tool and workpiece are mounted on rotary spindles. The rotational axes of the tool and workpiece are arranged at an angle to each other. The typical rolling motion is achieved by coupling the rotary movements of the tool and workpiece about the rotary axes. This rolling motion and an axial feed motion of the tool or the workpiece along the workpiece axis generate a cutting motion during gear skiving. Both external and internal gears can be machined with this process.

Combined lifting and pivoting movement of the pivot arm: This term is intended to express that both a lifting movement (with the aid of the lifting carriage) and a pivoting movement of the pivot arm take place. These movements can, but do not have to, take place simultaneously. They can also be performed one after the other, if necessary in several iterations of alternating lifting and pivoting movements.

Machine Tool with Tool Changer According to a First Embodiment

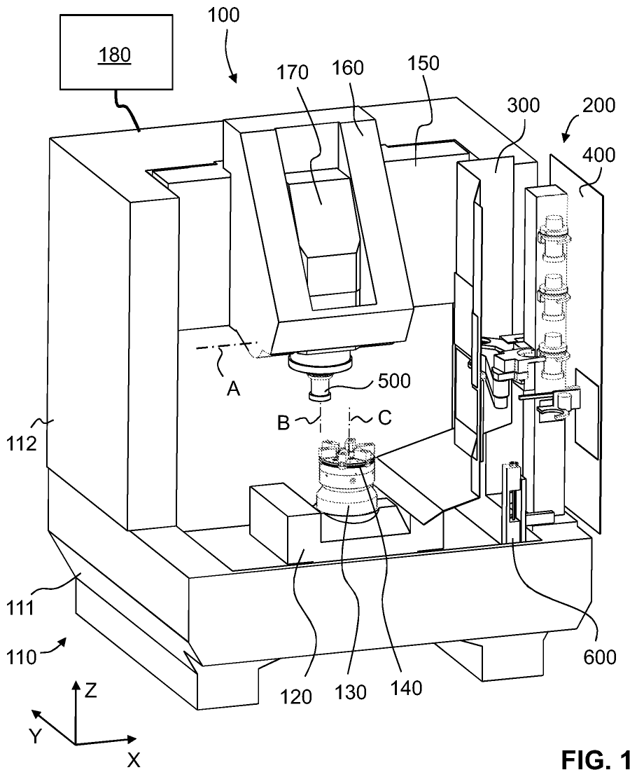

FIG. 1 shows an example of a machine tool 100 having a tool changer 200 according to a first embodiment of the present invention.

The machine tool 100 shown is a gear cutting machine which is particularly suitable for the gear skiving process. However, it is also possible to carry out other types of machining with such a machine, in particular other gear generating machining processes. In FIG. 1, the machine is shown only in a highly schematic manner. For details of a possible specific embodiment of the machine, reference is made to document CH715794B1, the disclosure of which is incorporated in its entirety by reference in the present disclosure. In the following, only some essential features of the machine will be explained in order to facilitate the understanding of the operation of the tool changer 200 subsequently explained.

The machine has a machine bed 110. The machine bed 110 is approximately L-shaped in side elevation, with a horizontal section 111 and a vertical section 112. A Y-carriage 120 is arranged on the horizontal section 111. The latter is displaceable along a Y-direction relative to the machine bed 110 by means of a drive not shown in drawing. The Y-direction runs horizontally in space.

The Y-carriage 120 carries a workpiece spindle 130 with a workpiece clamping means 140, with which a workpiece not shown in drawing can be clamped on the workpiece spindle 130. The Y-carriage 120 thus serves as a workpiece carrier.

The clamping means 140 is attached to the workpiece spindle 130 in such a way that it can be driven by the workpiece spindle 130 to rotate about a workpiece axis, the so-called C-axis. The C-axis extends vertically in space, that is, along the direction of gravity. The C-axis and the Y-direction together span a center plane of the machine. The center plane contains the C-axis, regardless of the position of the Y-carriage 120 along the Y-direction.

A Z-carriage 150 is arranged on the vertical section 112 of the machine bed 110. The Z-carriage is displaceable along a Z-direction relative to the machine bed 110 by means of a drive not shown in the drawing. The Z-direction here runs vertically in space, parallel to the

C-axis and perpendicular to the Y-direction.

On the Z-carriage 150, an X-carriage 160 is arranged which carries a tool spindle 170 and thus forms a tool carrier. The X-carriage 160 is displaceable along an X-direction relative to the Z-carriage 150 by means of a drive not shown in the drawing. The X-direction here runs horizontally in space, perpendicular to the Z-direction and to the Y-direction, and thus perpendicular to the center plane. Together, the Z-carriage 150 and the X-carriage 160 form a cross-carriage which permits displacements of the tool spindle 170 mounted thereon along the mutually perpendicular Z and X directions.

The tool spindle 170 drives a tool 500 mounted thereon, for example a gear skiving tool, to rotate about a tool axis, the so-called B axis. For this purpose, the tool 500 is provided with a tool support which may have, for example, a hollow taper shank according to DIN 69893-1:2011-04 or DIN 69893-6:2003-05 for connection to the tool spindle. By means of the tool support, the tool 500 is clamped in a clamping means of the tool spindle 170.

The tool spindle 170 can be pivoted about the so-called A-axis with respect to the X-carriage 160 by means of a drive not shown in the drawing. The A-axis is perpendicular to the B-axis, parallel to the X-axis and perpendicular to the center plane. The A-axis intersects the B-axis. The pivot plane in which the B-axis is pivoted is parallel to the center plane.

A control device 180 is used to control the machine. In particular, the control device 180 controls the pivot drive about the axis A, the spindle drives for the tool and workpiece axes B and C, and the drives for the linear displacements along the directions X, Y, and Z. The control device 180 interacts with a control panel, not shown in drawing, that allows an operator to enter control commands into the control device 180 and receive status messages.

For a possible configuration of the drives and guides for the movements of the Y-carriage 120, the Z-carriage 150 and the X-carriage 160 and for the pivoting movement of the tool spindle 170 about the A-axis, as well as for further construction details, reference is made to document CH715794B1.

Machining of a Workpiece

In order to machine a workpiece with a machine according to FIG. 1, the Y-carriage 120 is first brought into a workpiece change position against the Y-direction. In this position, the latest finished workpiece is removed from the clamping means 140 manually or with the aid of a workpiece loader not shown in the drawing, and a blank workpiece to be machined is placed on the clamping means 140 and clamped. Thereafter, the Y-carriage 120 is moved along the Y-direction into a machining position. If the blank workpiece is a pre-toothed workpiece, a meshing device not shown in the drawing is used to measure the tooth gaps of the blank workpiece in order to determine the angular position of these tooth gaps. Subsequently, the Z-carriage 150 and the X-carriage 160 are brought into a position in which the tool 500 engages the blank workpiece. At the same time, the tool spindle 170 is in an angular position about the A axis which depends, among other things, on the helix angle of the workpiece. Now, the gear generating machining of the blank workpiece is carried out in the usual manner. The tool 500 and the workpiece rotate at a defined rotational speed ratio. This forced coupling is effected electronically by the control device 180. By movements of the Z-carriage 150, an axial feed along the workpiece axis is realized. By movements of the X and/or Y carriage, the radial infeed of the tool relative to the workpiece axis can be changed. These movements are also controlled by the control device 180.

After a period of time, the cutting edges of the tool 500 are worn to such an extent that the tool 500 must be replaced with a freshly resharpened tool. The tool changer 200 described below is used for this purpose.

Structure of the Tool Changer

Tool Magazine and Tool Loading Station

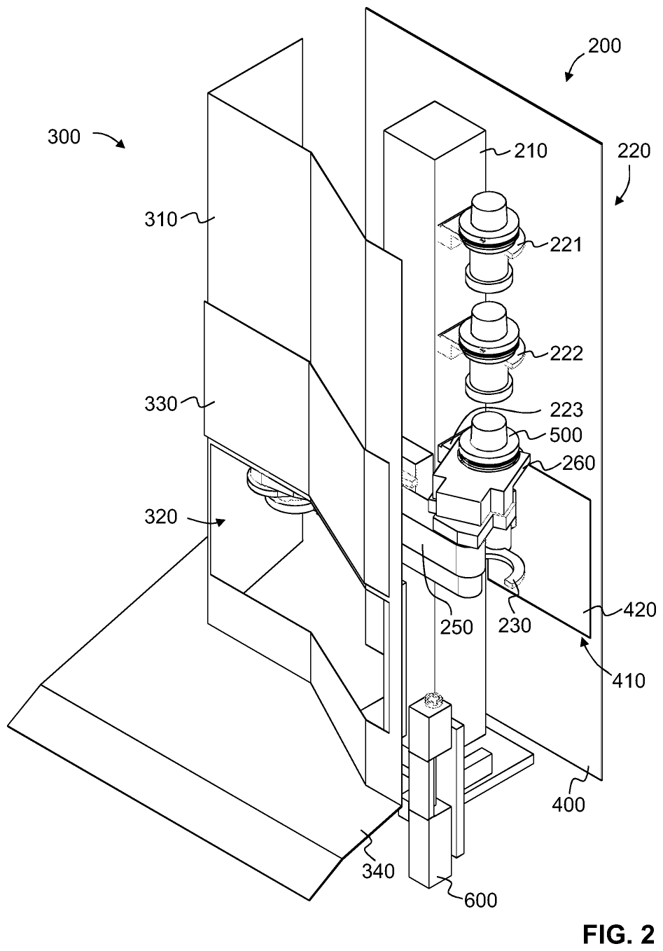

The tool changer 200 of the machine 100 is shown alone in FIG. 2. It has a support structure in the form of a vertical column 210 on which a plurality of (here three) tool holders 221, 222, 223 are rigidly arranged one above the other. These immovable tool holders are also referred to hereinafter as “tool storage locations”.

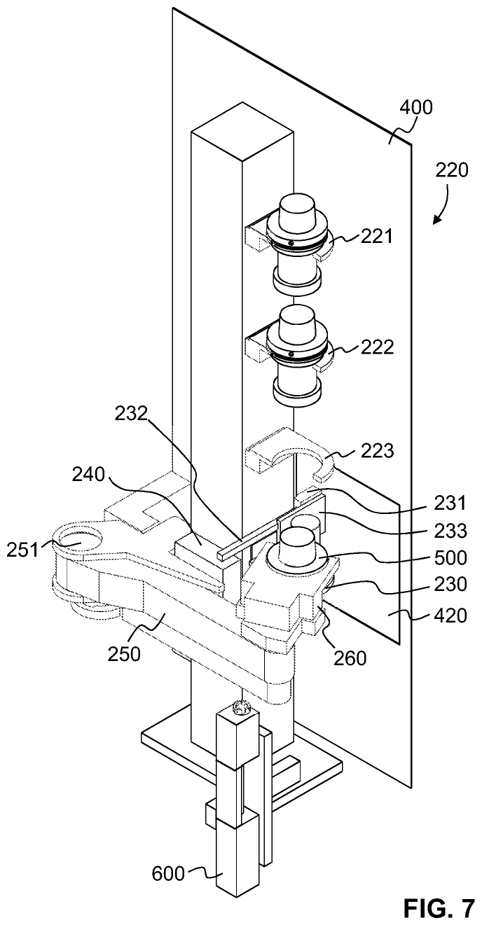

A further tool holder 230 is arranged below the lowest immovable tool holder 223. This tool holder is horizontally movable relative to the column 210, in particular horizontally displaceable and pivotable about a vertical axis. The movable tool holder 230 serves for transferring tools between the interior of the tool changer 200 and the exterior. It will also be referred to hereinafter as the “tool loading station”. The structure and function of the tool loading station will be explained in more detail below in connection with FIGS. 7, 8 and 9A to 9D. Of course, the tool loading station can also be arranged at a position between the immovable tool holders so that it is at an ergonomic height for the operator.

Each of the tool holders 221, 222, 223 and 230 is configured to receive a respective tool 500. For this purpose, the tool holders have a shape complementary to the shape of a corresponding portion of the tool. In the present example, the tool holders are formed as horizontal plates having an approximately semicircular recess. This recess receives a circular cylindrical tool portion of reduced diameter. A collar of the tool support arranged above with a larger diameter forms an annular bearing surface with which the tool rests on the area of the plate surrounding the recess. Of course, however, another form of tool holder is also conceivable.

A position sensor, not shown in drawing, at each tool holder 221, 222, 223 and 230 detects whether a tool 500 has been deposited in the relevant tool holder and reports this to the control device 180. The position sensor may, for example, be a simple mechanical switch which is actuated by a tool deposited in the relevant tool holder. In the example of FIG. 2, the three immovable tool holders (the tool storage locations) are each occupied by a tool 500, while the movable tool holder 230 (the tool loading station) is unoccupied.

The tool holders 221, 222, 223 and 230 form a tool magazine 220 for keeping a limited number of tools (here a maximum of four tools) directly available in the machine 100.

Bulkhead

A bulkhead 300 separates the tool changer 200 from the machining space of the machine tool 100. The bulkhead 300 serves to separate the interior of the tool changer 200 from the machining space of the machine tool 100, thereby protecting the interior of the tool changer 200 from contamination by cooling lubricant and/or chips.

The bulkhead 300 comprises a vertically extending bulkhead wall 310. Adjacent to the lower end of the bulkhead wall 310 is an apron 340 projecting downwardly at an angle into the machining space of the machine tool 100, through which cooling lubricant and/or chips can drain toward a chip conveyor, not shown, on the underside of the machine bed 110. A bulkhead opening 320 is formed in the vertical bulkhead 310, which is closable by a vertically slidable bulkhead door 330. An actuator not shown in the drawing, for example a pneumatic actuator well known in the prior art, is used to generate the opening and closing movement. This drive is controlled by the control device 180.

A safety switch signals the status of the bulkhead door 330 (open/closed) to the control device 180, preventing a workpiece from being machined in the machine tool while the bulkhead door 330 is open and preventing the swing arm 250 from moving through the bulkhead opening 320 when the bulkhead door 330 is closed.

Outer Wall with Tool Loading Door

On the side of the tool magazine opposite the bulkhead 300, an outer wall 400 is arranged to laterally separate the tool changer 200 from the exterior space. A tool loading opening 410 is formed in the outer wall 400, which is closable by a tool loading door 420. In the present example, the tool loading door 420 is pivotably mounted on the outer wall 400. It is opened and closed manually in the present example.

The outer wall 400 laterally delimits the machine 100 to the exterior space. The tool loading door 420 serves to protect the operator of the machine 100 from being injured by moving parts of the tool changer 200. In particular, the tool loading door 420 may be equipped with a status indicator that reports the status of the tool loading door 420 (open or closed) to the control device 180. The control device 180 ensures that the moving parts of the workpiece changer do not perform any movements as long as the tool loading door 420 is open, and otherwise prevents the tool loading door 420 from opening.

RFID Station

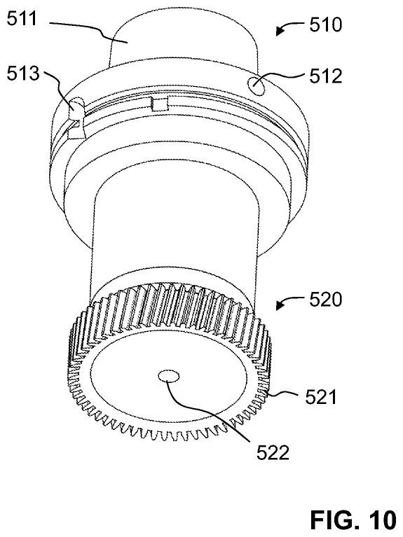

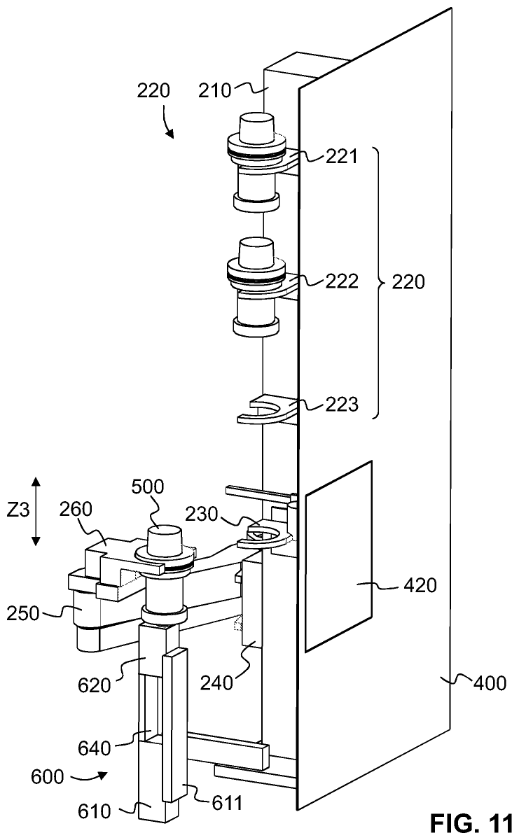

An RFID station 600 is located in the area between the bulkhead 300 and the outer wall 400, protected from cooling lubricant and chips. The structure and function of the RFID station 600 are explained in more detail below in connection with FIGS. 10 and 11.

Pivot Arm on Z3 Carriage

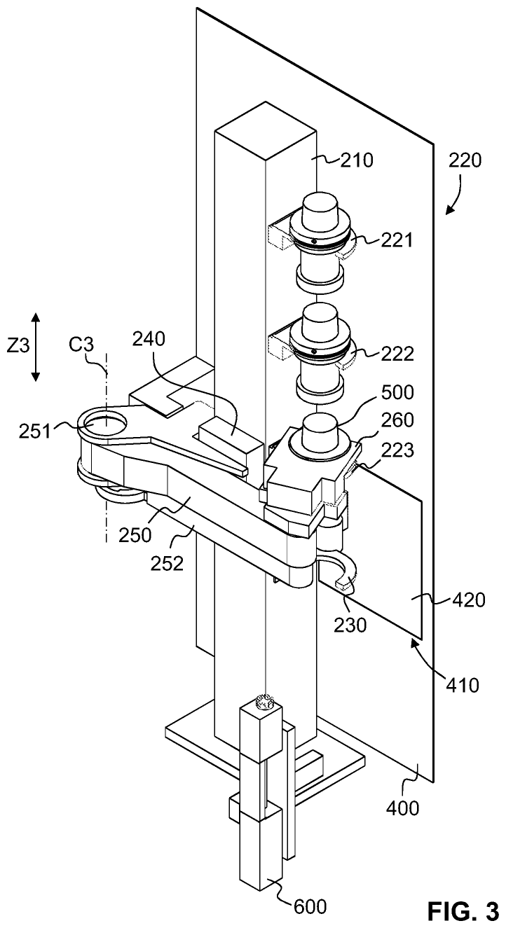

In FIG. 3, the tool changer 200 is shown without the bulkhead 300. In this figure, further components of the tool changer can be seen which are hidden by the bulkhead 310 in FIG. 2.

In particular, one can see a lifting carriage 240 which is guided vertically displaceably on the column 210. This lifting carriage is also referred to hereinafter as the “Z3 carriage”. The Z3 carriage 240 carries a pivot arm 250, which is pivotable about a vertical axis via a pivot bearing 251. This axis is also referred to herein as the “C3 axis”. The C3 axis extends at a distance from the column 210 in an area located between the column 210 and the machining space of the machine 100, or between the column 210 and the bulkhead 300.

A tool gripper 260, shown only schematically, is mounted to the free end of the pivot arm 250. The tool gripper enables a tool 500, which is deposited in one of the tool holders 221, 222, 223, 230, to be gripped and moved to another location. For this purpose, the tool gripper comprises two gripper jaws which are not shown individually in FIG. 3 and which are movable towards each other and with which the tool gripper grips the tool support of the tool 500 at its collar.

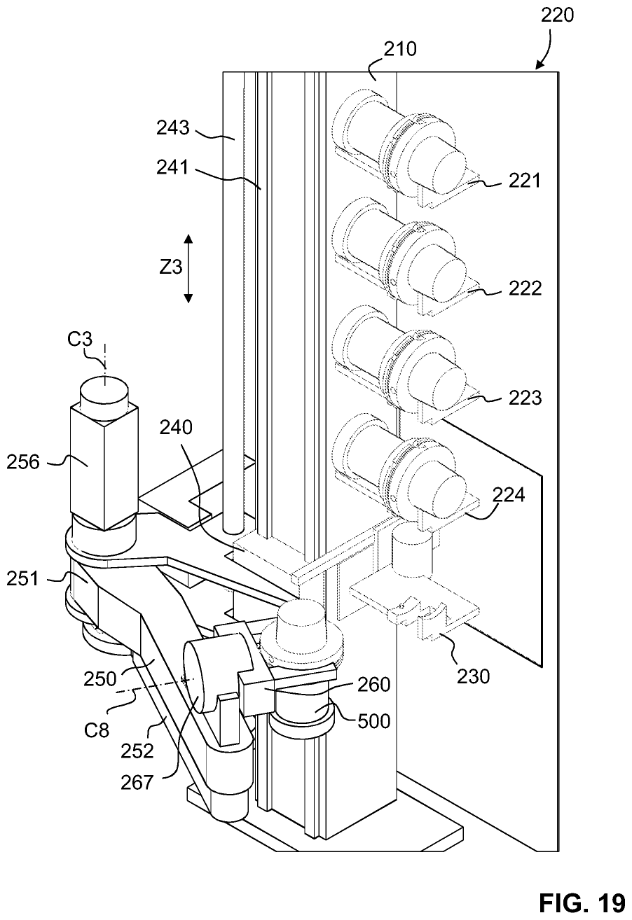

Below the pivot arm 250 is an auxiliary arm 252, the function of which is explained in more detail below in connection with FIGS. 19 to 22. The auxiliary arm 252 is inoperative in normal operation and is locked to the pivot arm 250 in a rest position.

Operation of the Tool Changer

Referring now to FIGS. 1 to 13, the operation of the tool changer 200 will be explained in more detail.

Intermediate Position (FIG. 1)

In FIG. 1, the Z3 carriage 240 and the pivot arm 250 are in an intermediate position, such as may typically be assumed during operation of the tool changer. In this position, the pivot arm 250 and the gripper 260 are entirely within the interior of the tool changer, which is delimited by the bulkhead 300 and the outer wall 400. The bulkhead door 330 may be closed in this position to protect the tool changer from contamination during machining of workpieces on the machine tool 100.

Removal of a Tool from the Tool Magazine (FIGS. 2 to 4)

In order to remove a tool from one of the tool holders 221, 222, 223 or 230, the tool gripper 260 is moved towards the tool 500 in question by means of the pivot arm 250 and the Z3 carriage 240. This is illustrated in FIGS. 2 to 4 for the lowest immovable tool holder. The tool gripper 260 grips the tool in question. The pivot arm 250 is then lifted slightly and pivoted out towards the bulkhead 310 until the tool is vertically above the RFID station 600. In this position, the pivot arm 250 with the tool gripper 260 and the tool held therein can be moved up and down collision-free along the Z3 direction by a movement of the Z3 carriage 240. Meanwhile, the bulkhead door 330 can remain closed.

The tool can then be deposited in another tool holder, moved to the RFID station 600, or moved to the tool spindle 170 by appropriate movements of the Z3 carriage 240 and the pivot arm 250.

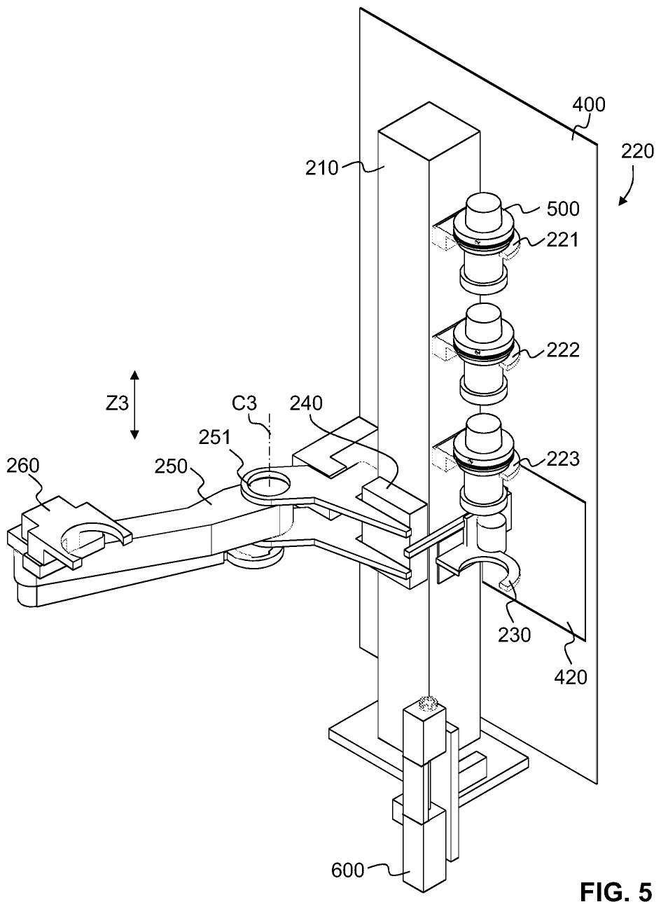

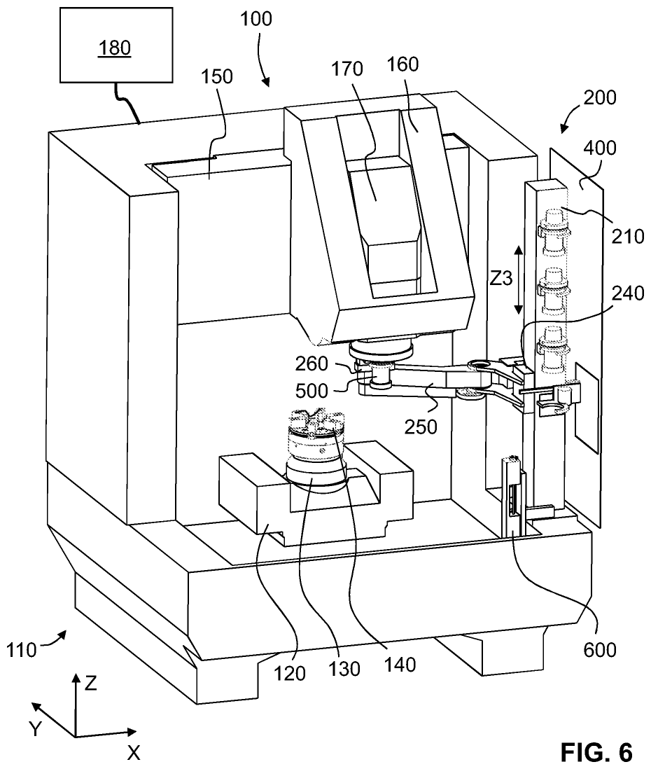

Transfer to the Tool Spindle (FIGS. 5 and 6)

To move a tool 500 to the tool spindle 170, the tool in question is removed from one of the tool holders as previously described and moved to a position directly behind the bulkhead door 330 using the Z3 carriage 240. The bulkhead door 330 is opened, and the pivot arm 250 is pivoted through the bulkhead opening 320 into the machining space of the machine tool 100 until the tool 500 held on the pivot arm 250 is located directly below the tool spindle 170. For this purpose, the tool spindle 170 has previously been brought into an appropriate position by means of the Z-carriage 150 and the X-carriage 160 and tilted about the A-axis into a vertical orientation. The resulting position of the tool spindle 170, the Z3 carriage 240 and the pivot arm 250 is illustrated in FIGS. 5 and 6. It will also be referred to hereinafter as the “clamping position”.

By moving the Z carriage 150 and/or the Z3 carriage 240, the tool 500 is now positioned relative to the tool spindle 170 in such a way that it can be clamped on the tool spindle 170 with the aid of a tool clamping means not shown in the drawing.

After the tool has been clamped on the tool spindle 170, the tool gripper 260 is opened and the pivot arm 250 is pivoted towards the rear of the machine. The tool spindle 170 is now removed with the X-carriage 160 from the collision area with the pivot arm 250. The pivot arm 250 can now be pivoted back into the interior of the tool changer 200 without collision.

The bulkhead door 330 is then closed again. Now workpieces can be machined with the newly clamped tool 500.

To remove the tool 500 from the tool spindle 170 again and move it into the tool magazine 220, this operation is performed in the reverse order.

Loading the Tool Magazine with New Tools (FIGS. 7, 8 and 9A to 9D)

FIGS. 7, 8 and 9A to 9D illustrate the transfer of a tool to the exterior space of the machine and the loading of a new tool into the tool magazine. In order to transfer a tool 500 from the interior of the tool changer 200 to the exterior of the machine, the tool in question is deposited on the movable tool holder 230 (the “tool loading station”) by appropriate movements of the Z3 carriage 240 and the pivot arm 250. Meanwhile, the tool loading door 420 is closed. This situation is illustrated in FIG. 7. The corresponding position of the Z-carriage 240 and the pivot arm 250 is also referred to hereinafter as the “transfer position”.

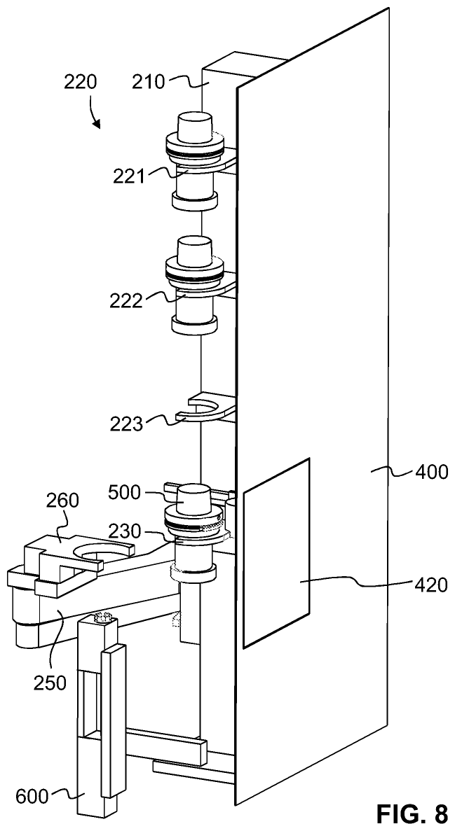

The tool gripper 260 is now opened, and the pivot arm 250 is pivoted away from the tool 500 concerned. The movable tool holder 230 is in its home position, in which it is arranged vertically exactly below the immovable tool holders 221, 222, 223. This situation is illustrated in FIG. 8. The now present position of the pivot arm 250 and the tool holder 230 also serves as a parking position, which the tool changer assumes during breaks in operation.

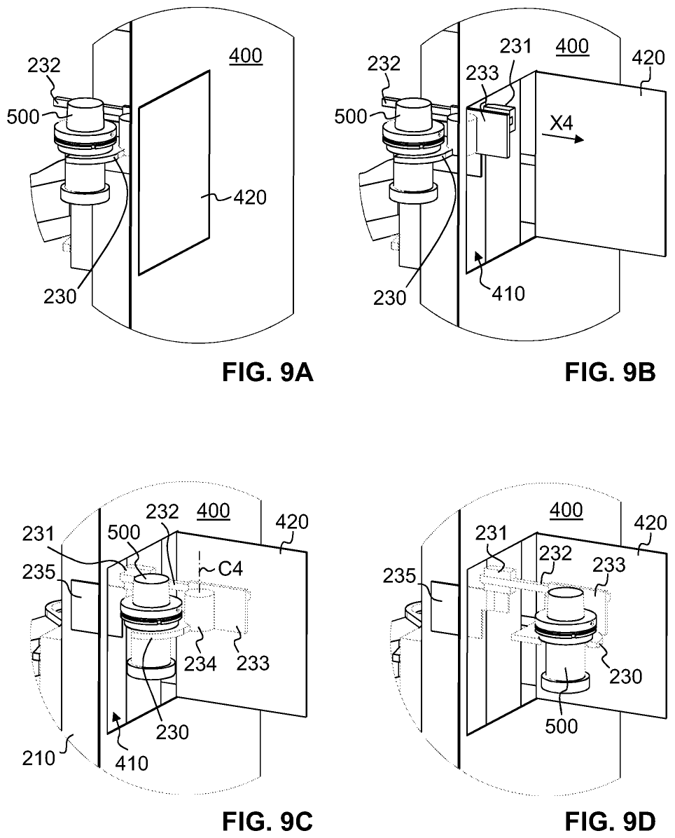

FIGS. 9A to 9D illustrate how the movable tool holder 230 is moved from this home position to a loading position. In each of these figures, the same section of the tool changer is shown.

In FIG. 9A, the movable tool holder 230 is in its home position, and the tool loading door 420 is closed.

The tool loading door 420 is now opened to expose the tool loading opening 410. The movable tool holder 230 is still in its home position. This is illustrated in FIG. 9B. In this figure, the manner in which the movable tool holder 230 is movable relative to the column 210 can also be seen. Via a holder 235 (see FIG. 9C), a linear guide 231 is rigidly connected to the column 210. This linear guide is also referred to hereinafter as the loading linear guide or the X4 linear guide. In the X4 linear guide 231, a running rail 232 is slidably guided along a horizontal direction X4. A plate 233 is mounted on the running rail 232. The running rail 232 and the plate 233 together form a carriage, which is slidably guided in the X4 linear guide 231 and will hereinafter be referred to as a loading carriage. The movable tool holder 230 is pivotably mounted to the plate 233 via a pivot bearing 234. The pivot bearing 234 defines a pivot axis C4 extending vertically in space (see FIG. 9C). It is therefore also referred to as a loading pivot bearing. The loading pivot bearing 234 allows the movable tool holder 230 to pivot relative to the loading carriage in a horizontal pivot plane.

The loading carriage with the movable tool holder 230 attached thereto and the tool 500 is now manually pulled through the tool loading opening 410 into the exterior space of the machine tool. The resulting intermediate position of the movable tool holder 230 is illustrated in FIG. 9C. In this intermediate position, the open side of the recess in the movable tool holder 230 faces towards the interior of the machine tool.

Finally, the movable tool holder 230 is additionally manually pivoted about the loading pivot axis C4 so that the open side of the recess in the movable tool holder 230 faces toward the operator. The resulting tool loading position of the tool holder 230 is illustrated in FIG. 9D.

In this position, the operator can readily remove the tool 500 and place a new tool in the tool holder 230.

To load the tool changer with a new tool, the steps described above are carried out in reverse order. In order to ensure that the tool is received in the tool changer in a predetermined orientation about its axis of rotation, a positioning element can be present on the movable tool holder 230, which interacts with a complementary structure on the tool. For example, the tool may have an orientation notch (“German corner”) according to DIN 69893-1:2011-4, and a complementary positioning pin may be provided on the movable tool holder 230.

After the movable tool holder 230 with the new tool has been pushed into the interior of the tool changer, the new tool can be transferred to one of the immovable tool holders 221, 222, 223 in the manner previously described. Preferably, the tool is previously detected at the RFID station 600, as will be described in further detail below.

In the above example, the movements of the movable tool holder 230 are performed manually. However, it is also conceivable to carry out these movements in a controlled manner by means of appropriate drives. In particular, it is conceivable to carry out an automatic exchange of tools between the movable tool holder 230 and an external magazine. For this purpose, an external manipulator can remove a tool from the movable tool holder 230 and load it with a new tool. The tool loading door 420 can be omitted in this case.

It is also conceivable to design the movable tool holder 230 differently from the example described above. For example, it is conceivable to mount the movable tool holder 230 to a pivot arm and to pivot it through the tool loading opening 410 into the exterior space with the aid of the pivot arm.

The tool loading door 420, if provided, may be a sliding door instead of a swinging door.

Detection of a Tool with the RFID Station (FIGS. 10 and 11)

The tool 500 may be provided with an RFID transponder, as illustrated in FIG. 10. FIG. 10 shows an exemplary tool 500. The tool 500 comprises a tool support 510. At the upper end, the tool support 510 is provided with a hollow taper shank (HSK) 511 of shape A according to DIN 69893-1:2011-04 or shape F according to DIN 69893-6:2003-05. At the outer circumference, the tool support 510 has the aforementioned orientation notch 513 (“German corner”) according to DIN 69893-1:2011-4. At the lower end, a skiving wheel 520 with end cutting edges 521 is connected to the tool support 510. Tool support 510 and skiving wheel 520 together form a tool 500 within the meaning of the present disclosure.

The skiving wheel 520 is provided with an RFID transponder 522 (“RFID tag”). The latter is located centrally on the underside of the skiving wheel, radially within the area in which the cutting edges 521 of the skiving wheel are arranged. With this RFID tag, the skiving wheel can be uniquely identified, and optionally further properties of the skiving wheel can be stored in this tag.

To read the RFID transponder 522 with the RFID station 600, the Z3 carriage 240 is moved downward until the tool 500 held by the tool gripper 260 contacts the top of the RFID station 600. This situation is illustrated in FIG. 11. This position of the Z3 carriage 240 and the pivot arm 250 is also referred to hereinafter as the “sensing position”.

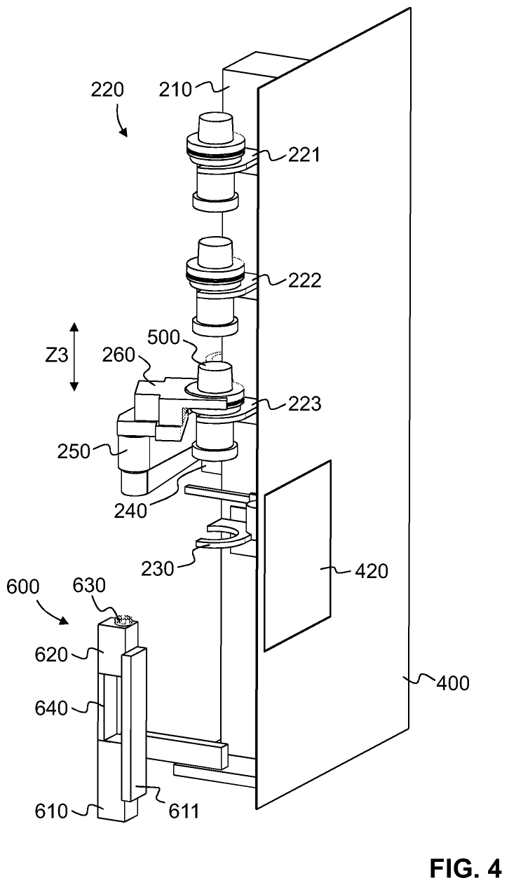

The RFID station 600 carries an RFID transceiver 630 on its top surface (visible in FIG. 4, hidden by the tool in FIG. 11) that reads the RFID transponder 522. The RFID transponder 522 stores a unique identifier of the skiving wheel 520. This unique identifier is read by the RFID transceiver 630 and transmitted to the control device 180. Using the unique identifier, the control device 180 retrieves process-relevant properties of the skiving wheel 520 from a database and uses these properties to control the machining process. These properties may include, for example: tool structure and geometric data, as well as data on previous use of the tool such as number of resharpenings performed and number of workpieces machined since the last resharpening. Alternatively, this data may be stored directly in the RFID transponder 522 and may also be read by the RFID transceiver 630. The RFID transceiver 630 may further be configured to write information to the RFID transponder 522.

To prevent damage to the RFID transceiver 630 and the associated RFID transponder 522, the RFID station 600 is of a spring-loaded design. To this end, the RFID transceiver 630 is mounted on a transceiver mount 620 that is vertically slidably guided on a base 610 via a guide rail 611. The base 610 is fixedly connected to the machine bed 110. A spring element 640 acts between the transceiver mount 620 and the base 610, compressing as the transceiver mount 620 moves down the guide rail 611. The spring element 640 thereby generates a restoring force on the transceiver mount 620. Preferably, the movement of the transceiver mount 620 relative to the base 610 is damped to prevent vibration. For example, the spring element 640 may be a gas spring known per se that generates both the restoring force and the damping effect. The spring-loaded design of the RFID station 600 makes it possible to use the RFID station 600 to read tools of different lengths without damaging the RFID transceiver 630 or the associated RFID transponder 522, even if the length of the tools is not known.

Preferably, a tool 500 is detected by the RFID station 600 immediately after a new tool is loaded into the tool changer. Alternatively, this detection can also be carried out when a tool is transferred to the tool spindle 170.

A further RFID transponder 512 is arranged in a peripheral region of the tool support 510. This RFID transponder is located in an installation space for data carriers, as defined in DIN 69893-1:2011-04. This RFID transponder can be used to uniquely identify the tool support, and optionally further properties of the tool support can be stored in this transponder. A second RFID transceiver, not shown in drawing, may be used to read the RFID transponder 512 in the tool support 510. This transceiver may be integrated into or located adjacent to the tool gripper 260, such as below the tool gripper.

The information read from the two RFID transponders 512 and 522 can uniquely identify the tool 500, and verify that the correct combination of skiving wheel 520 and tool support 510 is present.

Instead of an RFID transponder 512, 522, another type of machine-readable data carrier may be provided on the tool support 510 and/or on the skiving wheel 520, for example an optically readable code. Accordingly, instead of an RFID station, a suitably configured reading station may be provided, for example comprising an optical reading device for the data carrier instead of an RFID transceiver.

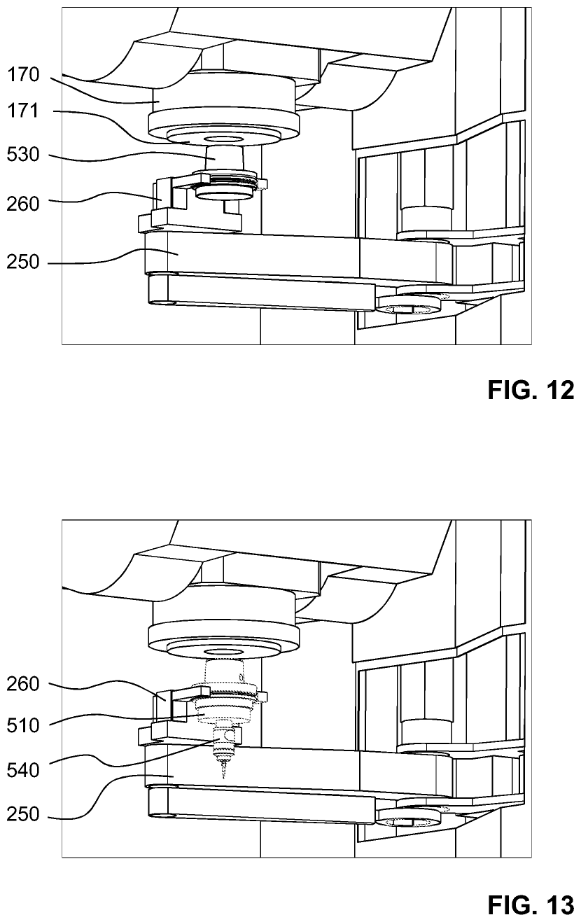

Use for Other Objects (FIGS. 12 and 13)

Referring to FIGS. 12 and 13, it is illustrated that objects other than tools 500 may be received in the tool gripper 260.

For example, in the example of FIG. 12, a taper cleaner 530 is received in the tool gripper 260 for a taper receptacle 171 in the tool spindle 170. This may be a commercially available taper cleaner mounted on a suitable interface with the tool gripper 260. The taper cleaner 530 is gripped by the tool gripper 260 and moved to the tool spindle 170 by the pivot arm 250 and the Z3 carriage 240, and inserted into the slowly rotating taper receptacle. Instead of a taper cleaner, a brush may be used, for example.

In the example of FIG. 13, a measuring probe 540 is received in the tool gripper 260. This measuring probe may perform general measuring and inspection functions. It may be equipped with a means for wireless signal transmission. For example, the measuring probe 540 may be used to perform a runout and axial runout measurement of the workpiece clamping means 140. For this purpose, the measuring probe 540 is moved to the workpiece clamping means 140 by means of the pivot arm 250 and the Z3 carriage 240. Alternatively, the measuring probe 540 may be inserted into the tool spindle 170 or at another location on the machine tool 100.

Instead of a taper cleaner 530 or a measuring probe 540, other objects may be gripped by the tool gripper 260. They can be placed in one of the tool trays when not in use.

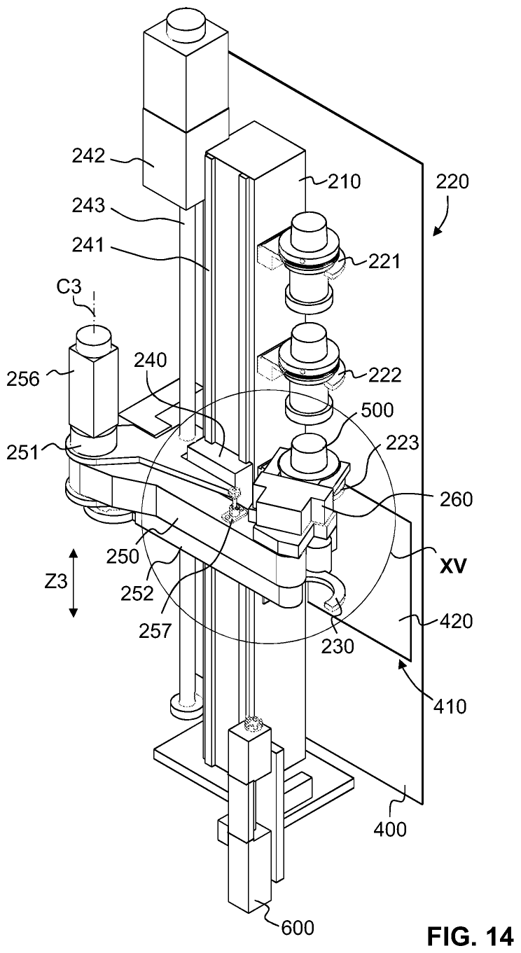

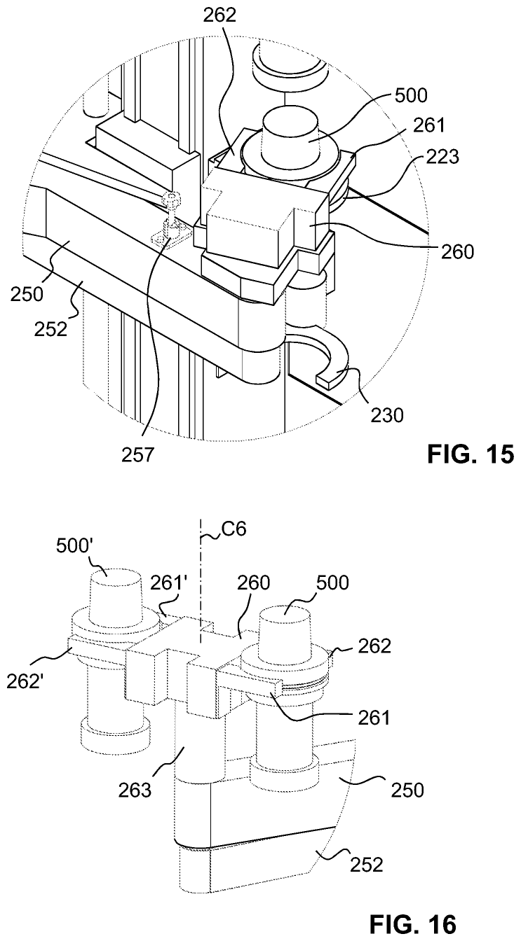

Guide and drive of the Z3 carriage, drive of the pivot arm, tool gripper, locking of the auxiliary arm (FIGS. 14 and 15)

For clarity, some components of the tool changer have not been illustrated in FIGS. 1-13. FIGS. 14 and 15 illustrate these components.

The Z3 carriage 240 is guided in a manner known per se by two parallel guide rails 241, which are rigidly connected to the column 210. The Z3 carriage is driven by a lifting carriage drive 242, which generates a rotary motion that is transferred into a lifting motion of the Z3 carriage 240 by a ball screw 243 known per se.

The pivoting movement of the pivot arm 250 about the C3-axis is performed by means of a pivot actuator 256, known per se, which is attached to the Z3-carriage 240.

A latch 257 secures the auxiliary arm 252 to the pivot arm 250. This latch may be configured, for example, as a spring-loaded pin that extends through the pivot arm 250 into an opening in the auxiliary arm 252 in a latched position and is pulled out far enough to allow pivoting of the auxiliary arm 252 relative to the pivot arm 250 in a release position.

The tool gripper 260 can be seen in more detail in FIG. 15. The tool gripper 260 is a two-jaw gripper known per se with a pair of gripper jaws 261, 262 which are pneumatically or electrically movable towards each other to grip a tool. The shape of the gripper jaws 261, 262 is thereby adapted to the outer shape of the tool area to be picked up by the tool gripper. In particular, the gripper jaws 261, 262 may be shaped such that a tool gripped by them is form-fittingly secured against falling out. For example, the tool support 510 may be provided with a hollow taper shank (HSK) of shape A according to DIN 69893-1:2011-04 or of shape F according to DIN 69893-6:2003-05. Such a hollow taper shank has a collar with a circumferential gripping groove. The gripper jaws can then have inwardly projecting protrusions that engage in this gripping groove.

The lifting carriage drive 242, the pivot drive 255 and the tool gripper 260 are controlled by the control device 180 (see FIG. 1).

Of course, other types of guides, drives, grippers and latches than in the present example are also conceivable.

Second Embodiment (FIG. 16)

A second embodiment of a tool changer is illustrated in FIG. 16. The tool changer of the second embodiment differs from the tool changer of the first embodiment only in the design of the tool gripper 260 and the manner in which it is mounted to the pivot arm 250.

In the second embodiment, the tool gripper 260 is configured as a double gripper. For this purpose, the tool gripper 260 comprises two pairs of gripper jaws 261, 262 or 261′, 262′. The pair of gripper jaws 261′, 262′ extends in the opposite direction to the pair of gripper jaws 261, 262. The tool gripper 260 is mounted at the free end of the pivot arm 250 to a pivot body 263 in which a pivot drive is integrated. This pivot body 263 allows the tool gripper to pivot between 0° and 360° about a vertical axis C6. This allows the positions of the pairs of gripper jaws 261, 262 and 261′, 262′ to be interchanged.

By designing the tool gripper 260 as a double gripper, it becomes possible to remove a worn tool 500′ from the tool spindle 170 and replace it with a freshly resharpened tool 500 without having to move the pivot arm 250 through the bulkhead opening 320 multiple times. To this end, the pair of gripper jaws 261, 262 remove the freshly resharpened tool 500 from the tool magazine in the manner previously described. The pair of gripper jaws 261′, 262′ remains empty. The tool 500 is now transferred to the tool spindle 170 through the bulkhead opening 320 by the pivot arm 250 in the manner previously described. Now the pair of gripper jaws 261′, 262′ picks up the worn tool 500′ from the tool spindle 170. The tool gripper 260 is pivoted 180°, and the pair of gripper jaws 261, 262 transfers the freshly resharpened tool 500 to the tool spindle 170. The pivot arm 250 is now pivoted back into the interior of the tool changer 200.

In this way, unproductive downtime during tool changes can be reduced.

The pairs of gripper jaws may also be arranged differently than in FIG. 16, and the tool gripper may be connected to the pivot arm 250 differently than in FIG. 16. For example, the pairs of gripper jaws may be arranged side by side on the same side of the tool gripper 260. More than two pairs of gripper jaws may also be provided.

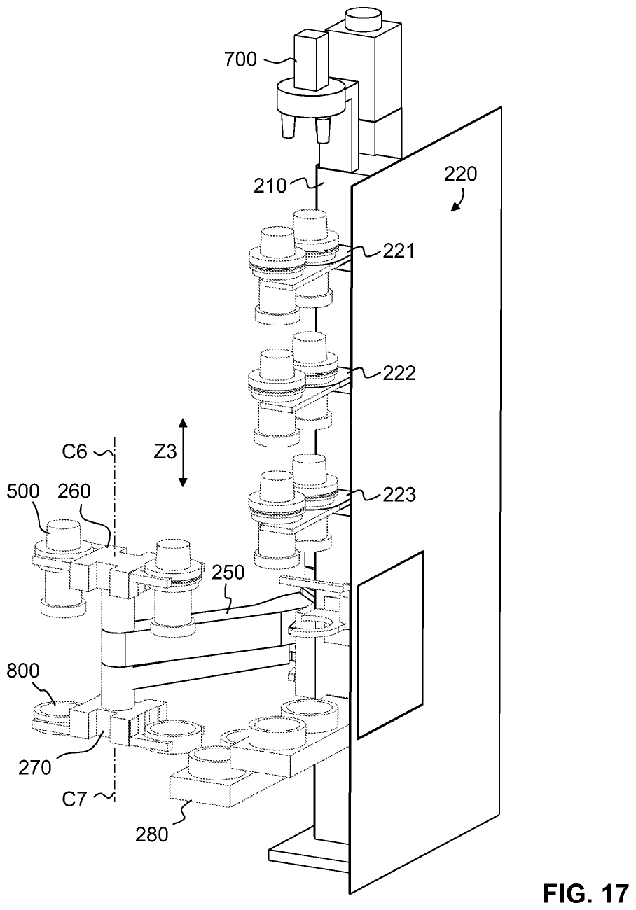

Third Embodiment (FIG. 17)

A third embodiment of a tool changer is illustrated in FIG. 17. In the third embodiment, the tool gripper 260 is configured as a double gripper as in the second embodiment and is pivotable about a vertical pivot axis C6 relative to the pivot arm 250. The immovable tool holders 221, 222, 223 are now configured as double receptacles, i.e. they can each receive two tools next to each other. In order to deposit a tool in one of these tool holders or to pick it up from one of these tool holders, the tool gripper 260 can be brought into corresponding pivot positions. In this way, the capacity of the tool magazine 220 can be doubled with minimal additional space required.

In addition, the tool changer of the third embodiment optionally further comprises a workpiece gripper 270 configured to pick up workpieces 800 from a workpiece rest 280 and transfer them to the workpiece clamping means 140 of the workpiece spindle 130 in a corresponding position of the pivot arm 250. The controller 180 may have a corresponding control program for this purpose.

In the present example, the workpiece gripper 270 is also configured as a double gripper in order to minimize unproductive idle times during the workpiece change. However, the workpiece gripper 270 can of course also be configured as a single gripper. It can also be combined with a single gripper for the tools.

An optional tool cleaner 700 is arranged at the upper end of the column 201. This is used to clean coolant and chips from the hollow tapered shank 511 of the tool support 510 of a tool 500 (see FIG. 10). It is therefore also referred to as a taper cleaner. The tool cleaner 700 is arranged such that a tool 500 held by the gripper 260 can be readily moved to the tool cleaner by means of the Z3 carriage 240 and the pivot arm 250. In the present example, the tool cleaner 700 is arranged above the immovable tool holders 221, 222, 223, but this is not mandatory.

Of course, a tool cleaner may also be provided in any of the other embodiments described herein. Suitable tool cleaners are known from the prior art and are commercially available.

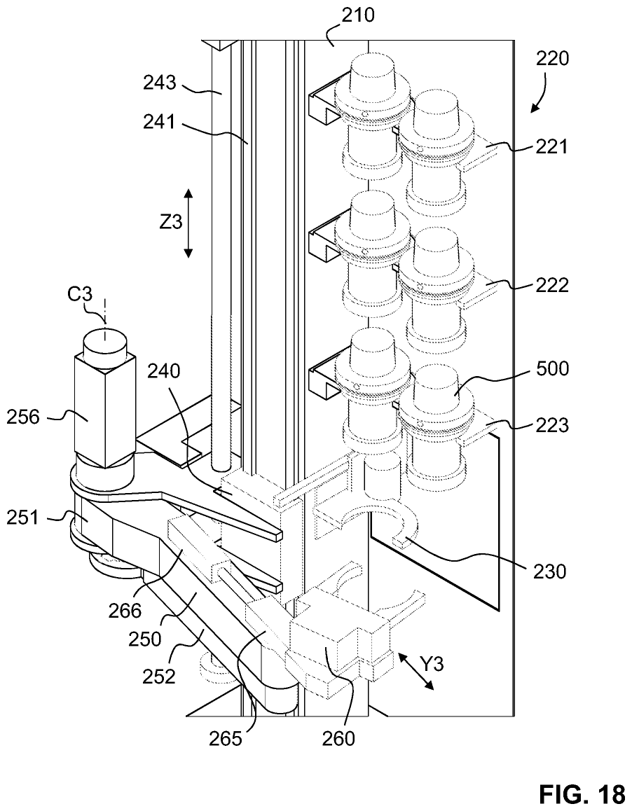

### Fourth Embodiment (FIG. 18)

A fourth embodiment of a tool changer is illustrated in FIG. 18. In this embodiment, the tool gripper 260 is linearly displaceable relative to the pivot arm 250 along a direction Y3. For this purpose, the tool gripper 260 is mounted on a gripper carriage 265 which is displaceable in a controlled manner along the direction Y3 relative to the pivot arm 250 by means of a gripper carriage drive 266.

In the present example, the direction Y3 is substantially parallel to the longitudinal direction of the pivot arm 250, but may be at any angle to that direction.

In this embodiment, the tool gripper may also be a double gripper as described in the context of the second and third embodiments. It may then be mounted on the gripper carriage 265 via a pivot body. However, a pivot body may also be omitted, for example, if the pairs of gripper jaws are arranged side by side.

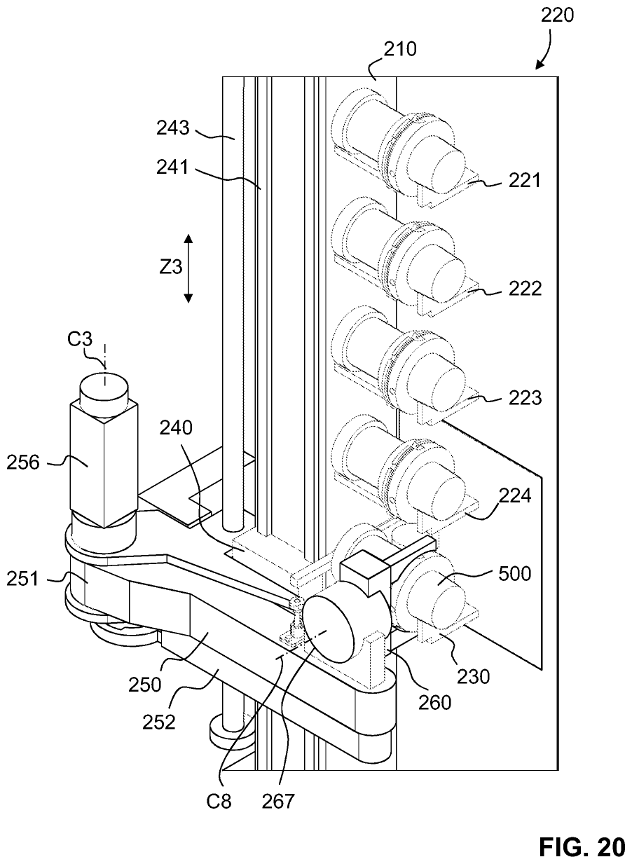

Fifth Embodiment (FIGS. 19 and 20)

A fifth embodiment of a tool changer is illustrated in FIGS. 19 and 20. In this embodiment, the tool gripper 260 is attached to a pivot body 267 with an integral drive that allows the tool gripper 260 to pivot 90° in a controlled manner about a horizontal pivot axis C8 relative to the pivot arm 250. As a result, the tools 500 can be deposited in a horizontal orientation in tool holders 221, 222, 223, 224 and 230 instead of in a vertical orientation. Accordingly, the tool holders are each configured to receive a tool 500 in an orientation in which the tool axis is horizontal. By depositing the tools horizontally, the space required for long tools is markedly reduced.

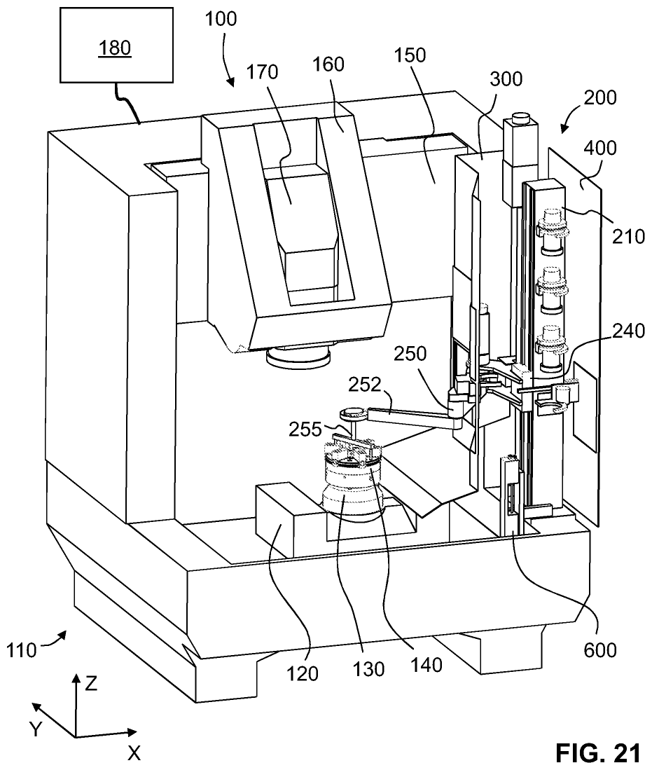

Changing the Clamping Means (FIGS. 21 to 23)

The tool changer 200 not only allows a tool to be automatically changed on the tool spindle 170, but also allows the operator to be assisted in changing the workpiece clamping means 140. This is illustrated in FIGS. 21 to 23 with reference to the first embodiment.

For changing the clamping means, the aforementioned auxiliary arm 252 is pivotably mounted at the free end of the pivot arm 250, below the tool gripper 260, via a pivot bearing 253. In normal operation, the auxiliary arm 252 is locked to the pivot arm 250 in a rest position. The latch 257 described above is used for this purpose. The rest position is monitored by a sensor, which is not shown, in order to prevent damage to the machine during normal operation. The auxiliary arm 252 can be unlocked for changing the clamping means, so that it can be pivoted manually with respect to the free end of the pivot arm 250 about a vertical auxiliary pivot axis C5 in a horizontal plane. The auxiliary pivot axis C5 is arranged at a distance from the pivot axis C3 of the pivot arm 250. At the free end of the auxiliary arm 252, there is a bayonet-type receptacle 254 for a clamping means holder 255.

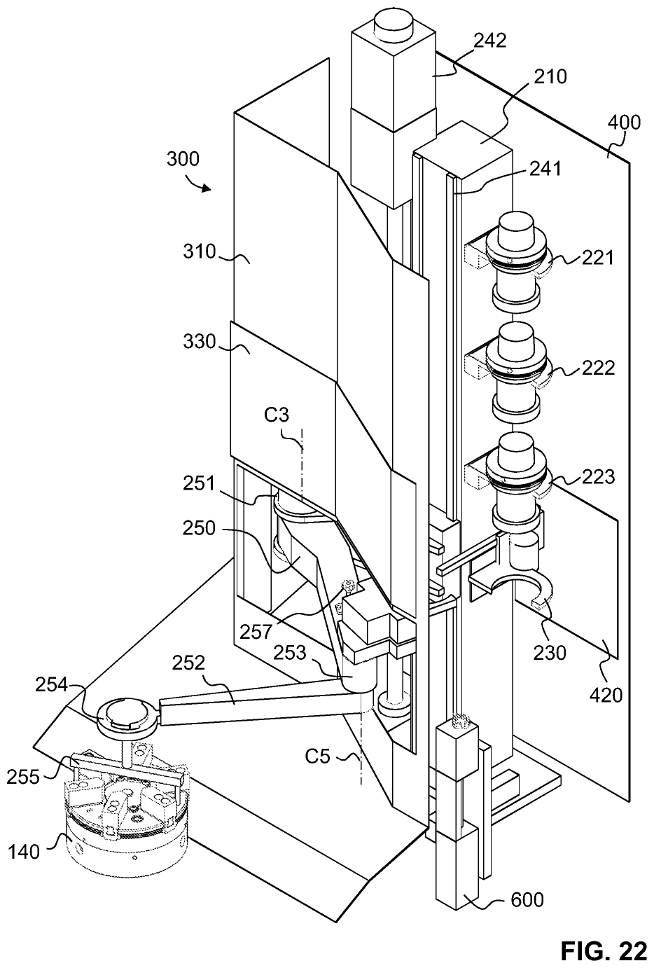

To perform a clamping means change, the Z-carriage 150 is first moved all the way up along the positive Z-direction, and the X-carriage 160 is moved all the way to the left along the negative X-direction, i.e., away from the tool changer 200, to avoid collisions with the pivot arm 250 and the auxiliary arm 252. The Y-carriage 120 is moved all the way forward along the negative Y-direction to make it as well accessible as possible to the operator. Subsequently, the Z3-carriage 240 and the pivot arm 250 are moved to a position illustrated in FIGS. 21 and 22. The operator now releases the latch of the auxiliary arm 252 and manually pivots the auxiliary arm 252 out of the rest position. He attaches the clamping means holder 255 to the receptacle 254 and manually brings the auxiliary arm 252 into the position illustrated in FIGS. 21 and 22. The clamping means holder 255 is now directly above the clamping means 140. This position is also referred to as the clamping means change position.

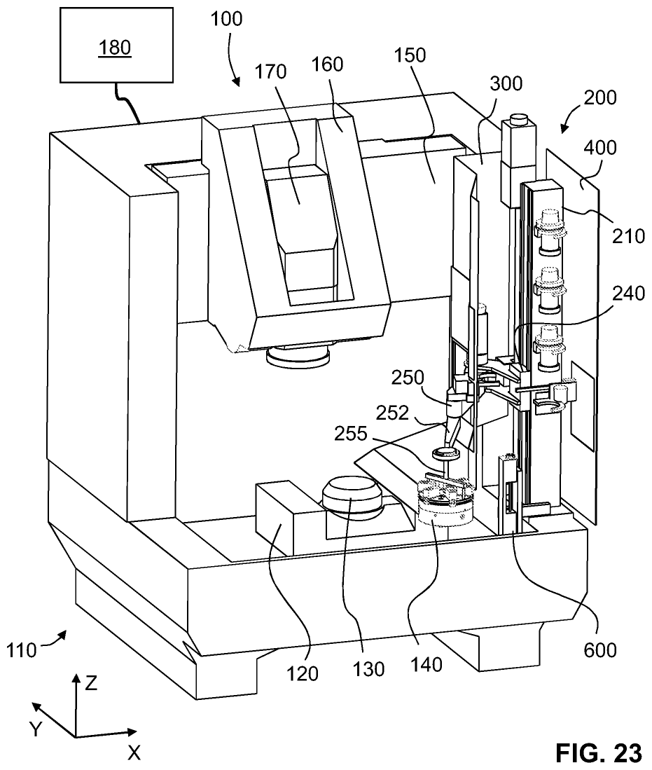

By a downward movement of the Z3-carriage, the clamping means holder 255 is now placed on the clamping means 140. The clamping means holder 255 is then connected to the clamping means 140, for example by a screw connection, and released from the workpiece spindle 130. By an upward movement of the Z3-carriage 240, the clamping means 140 is lifted from the workpiece spindle 130 and pivoted forward out of the machining space of the machine tool 100 with the aid of the auxiliary arm 252. The resulting removal position is illustrated in FIG. 23. The clamping means 140 can now be deposited on a clamping means rest not shown in the drawing, for example a carriage, by a downward movement of the Z3-carriage 240.

In order to prevent unwanted pivoting movements of the auxiliary arm 252, a detent device may be provided on the pivot bearing 253 to lock the auxiliary arm 252 in one or more selected detent positions. This detent device may be configured to allow the auxiliary arm 252 to pivot out of these detent positions only after overcoming a certain release torque about the auxiliary pivot axis C5. For this purpose, the detent device may comprise, for example, a spring thrust piece which engages in a respective recess in a control plate of the pivot bearing in the detent positions. Alternatively, a manually operable clamping means may be provided to enable the auxiliary arm 252 to be fixed in any pivoted position, or the pivot bearing 253 may be configured to provide a certain degree of friction against a pivoting movement so as to prevent inadvertent pivoting of the auxiliary arm 252.

To prevent damage to the clamping means 140 when the clamping means holder 255 is placed on the clamping means 140, the clamping means holder 255 may be formed to be spring-loaded in compression along the Z-direction.

While the change of clamping means has been explained with reference to the first embodiment, a change of clamping means may also be performed in a very similar manner in all other embodiments.

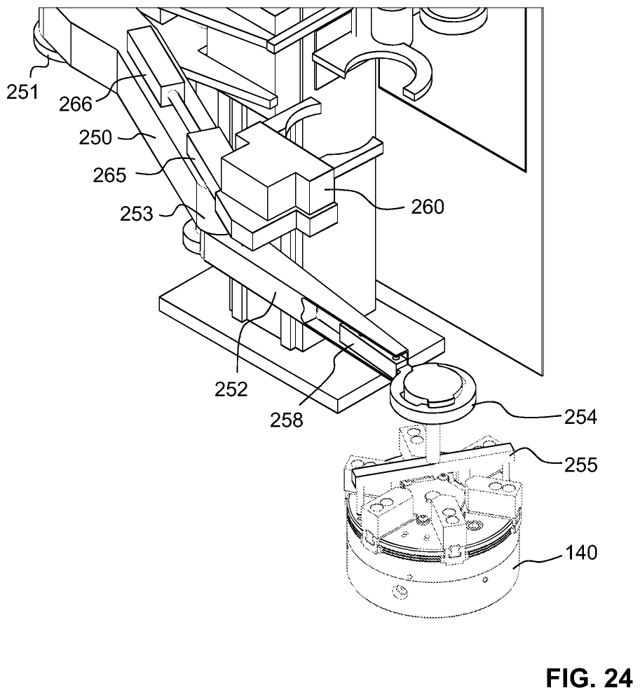

Variant with Force Transducer (FIG. 24)

The receptacle 254 for the clamping means holder 255 may be attached to the auxiliary arm 252 via a force transducer 258. This is illustrated in FIG. 24. The force transducer 258 measures the force generated by the weight of the clamping means 140 suspended from the mount 253. The force transducer 258 transmits signals indicative of the determined force to the control device 180, thereby enabling the control device 180 to detect excessive loading of the system comprising the pivot arm 250 and the auxiliary arm 252, to warn the operator accordingly and, if necessary, to stop further operation of the tool changer. A warning may also be issued in the event that, for example, the connection between the clamping means 140 and the workpiece spindle 130 has not been correctly released, so that the clamping means 140 cannot be lifted off.

Suitable force transducers are known in the prior art and are commercially available.

While the force transducer in FIG. 24 is illustrated in combination with the fourth embodiment, a force transducer may be used in any other embodiment.

Other Variations

Of course, various further variations of the tool changer described above are possible without departing from the scope of the invention as defined in the claims.

For example, it is conceivable to design the support structure differently than shown above. For example, it is conceivable that two parallel columns are provided as the support structure instead of a single column 210, with the tool holders being attached to one of these columns, while the other column serves to guide the Z3-carriage.

### LIST OF REFERENCE SIGNS

100 Machine tool
110 Machine bed
111 Horizontal section
112 Vertical section
120 Y-carriage
130 workpiece spindle
140 workpiece clamping means
150 Z-carriage
160 X-carriage
170 Tool spindle
171 Taper receptacle
180 Control device
200 Tool changer
210 Column
220 Tool magazine
221-224 Immovable tool holder (tool storage location)
230 Movable tool holder (tool loading station)
231 X4 guide
232 X4 running rail
233 Plate
234 Pivot bearing
235 Holder
240 Lifting carriage (Z3 carriage)
241 Guide rail
242 Lifting carriage drive
243 Ball screw
250 Pivot arm
251 Pivot bearing
252 Auxiliary arm
253 Pivot bearing
254 Receptacle
255 Clamping means holder
256 Pivot drive
257 latch of the auxiliary arm
258 Force transducer
260 Tool gripper
261, 262 Gripper jaws
261′, 262′ Gripper jaws
263 Pivot bearing with drive
265 Gripper carriage
266 Gripper carriage drive
267 Pivoting body with drive
270 Workpiece gripper
280 Workpiece rest
300 Bulkhead
310 Bulkhead wall
320 Bulkhead opening
330 Bulkhead door
340 Apron
400 Outer wall
410 Tool loading opening
420 Tool loading door
500, 500′ Tool
510 Tool support
511 Taper hollow shaft
512 RFID transponder
513 Orientation notch (“German Corner”)
520 Skiving wheel
521 Cutting edge
522 RFID transponder
530 Taper cleaner
540 Measuring probe
600 RFID station
610 Base
611 Guide rail
620 Vertical trolley
630 RFID transceiver
640 Spring element
700 Tool cleaner
800 Workpiece
X, Y, Z Linear axes of the machine tool
A Pivot axis of the tool spindle
B Tool axis
C Workpiece axis
Z3 Linear axis of the Z3-carriage
Y3 Linear axis of the gripper carriage
C3 Pivot axis of the pivot arm
X4 Direction of displacement of the movable tool holder
C4 Pivot axis of the moving tool holder
C5 Auxiliary pivot axis of the auxiliary arm
C6 Vertical pivot axis of the tool gripper
C7 Vertical pivot axis of the workpiece gripper
C8 Horizontal pivot axis of the tool gripper

1-21. (canceled)

22. A tool changer for changing tools in a machine tool, comprising:
a support structure;
a lifting carriage which is guided on the support structure along a lifting direction extending vertically in space;
a pivot arm which is pivotably mounted to the lifting carriage so that it is pivotable about a pivot axis extending vertically in space;
a tool gripper mounted on the pivot arm and configured to grip a tool; and
a tool magazine with a plurality of tool holders arranged vertically one above the other,
wherein the tool changer is configured to move a tool gripped by the tool gripper by a combined lifting and pivoting movement of the pivot arm selectively between one of the tool holders and a tool spindle of the machine tool or between two different tool holders of the tool magazine.

23. The tool changer of claim 22,
wherein the support structure comprises a vertical column configured to be mounted at a lower end on a machine bed of the machine tool,
wherein the lifting carriage is guided along the lifting direction on the column, and
wherein the tool holders are mounted to the column.

24. The tool changer of claim 22, wherein one of the tool holders is mounted movably to the support structure to facilitate loading of the tool magazine.

25. The tool changer of claim 24, comprising an outer wall separating an interior space of the tool changer from an exterior space,
wherein the outer wall has a tool loading opening for exchanging tools between the interior space and the exterior space,
wherein the movable tool holder is movable through the tool loading opening.

26. The tool changer of claim 24, comprising:
a loading linear guide; and
a loading carriage displaceably guided along the horizontal loading direction on the loading linear guide,
wherein the movable tool holder is mounted on the loading carriage so as to be pivotable about the vertical loading pivot axis.

27. The tool changer of claim 22, further comprising a bulkhead configured to separate an interior space of the tool changer from a machining space of the machine tool,
wherein the bulkhead comprises a bulkhead opening,
wherein the tool changer comprises a bulkhead door configured to selectively close or open the bulkhead opening, and
wherein the pivot arm with the tool gripper mounted thereto is movable through the bulkhead opening in at least one position of the lifting carriage.

28. The tool changer of claim 22, further comprising a reading station for reading a machine readable data carrier on the tool,
wherein the reading station is arranged such that a tool held by the tool gripper is movable to the reading station by a combined lifting and pivoting movement of the pivot arm in order to read the data carrier on the tool.

29. The tool changer of claim 28, wherein the reading station comprises a base, a reading device for reading the data carrier and a spring element arranged therebetween, in such a way that the reading device is movable vertically downwards relative to the base against a restoring force generated by the spring element.

30. The tool changer of claim 22, further comprising a tool cleaner,
wherein the tool cleaner is arranged such that a tool held by the tool gripper is movable towards the tool cleaner by a combined lifting and pivoting movement of the pivot arm to clean a tool support of the tool.

31. The tool changer of claim 22, wherein the tool gripper is configured as a multiple gripper having at least two pairs of gripper jaws for gripping two or more tools.

32. The tool changer of claim 22, wherein the tool gripper is movably attached to the pivot arm.

33. The tool changer of claim 22, further comprising at least one of:
a taper cleaner for cleaning a taper receptacle of the tool spindle, the taper cleaner being grippable by the tool gripper so as to be movable towards the tool spindle by a combined lifting and pivoting movement of the pivot arm, and
a measuring probe, wherein the measuring probe is grippable by the tool gripper so that it can be moved into a measuring position by a combined lifting and pivoting movement of the pivot arm.

34. The tool changer of claim 22, further comprising a workpiece gripper which is mounted on the pivot arm and which is configured to pick up workpieces from a workpiece rest and to transfer them to a workpiece spindle of the machine tool.

35. The tool changer of claim 22, further comprising:
a lifting carriage drive for driving the lifting carriage to perform a lifting movement along the lifting direction;
a pivot drive for driving the pivot arm to perform a pivoting movement relative to the lifting carriage about the pivot axis; and
a control device configured to control the lifting carriage drive, the pivot drive and the tool gripper.

36. The tool changer of claim 35, wherein the control device is configured to effect at least one of the following operations:
a) gripping a tool with the tool gripper;
b) moving a tool gripped by the tool gripper between one of the tool holders and a tool spindle of the machine tool by a combined lifting and pivoting movement of the pivot arm;
c) moving a tool gripped by the tool gripper between two different tool holders of the tool magazine by a combined lifting and pivoting movement of the pivot arm.

37. The tool changer of claim 22, further comprising:
an auxiliary arm pivotably mounted to the pivot arm about a vertically extending auxiliary pivot axis such that the auxiliary pivot axis of the auxiliary arm and the pivot axis of the pivot arm are parallel and spaced apart from one another, and
wherein the auxiliary arm is configured to have a workpiece clamping means of the machine tool attached thereto.

38. The tool changer of claim 37, further comprising:
a clamping means holder which is configured to be detachably connected to the auxiliary arm and the workpiece clamping means in such a way that the workpiece clamping means is attached to the auxiliary arm via the clamping means holder.

39. The tool changer of claim 37, wherein a force transducer is arranged on the auxiliary arm to detect a load on the auxiliary arm in the vertical direction.

40. A machine tool, comprising:
a machine bed;
a tool spindle for driving a tool to rotate about a tool axis; and
a tool changer according to claim 22,
wherein the tool changer is arranged on the machine bed in such a way that a tool gripped by the tool gripper is movable from one of the tool holders to the tool spindle by a combined lifting and pivoting movement of the pivot arm.

41. The machine tool of claim 40, further comprising a workpiece spindle having a workpiece clamping means,
wherein the tool changer comprises an auxiliary arm pivotably mounted to the pivot arm about a vertically extending auxiliary pivot axis such that the auxiliary pivot axis of the auxiliary arm and the pivot axis of the pivot arm are parallel and spaced apart from one another,
wherein the auxiliary arm is configured to have a workpiece clamping means of the machine tool attached thereto, and
wherein the workpiece spindle is arranged on the machine bed in such a way that the workpiece clamping means of the workpiece spindle can be attached to the auxiliary arm when the latter is pivoted out of the rest position relative to the pivot arm.

42. The tool changer of claim 24, wherein said one of the tool holders is at least one of:
movable along a horizontal loading direction, and
pivotable about a vertical loading pivot axis.

43. The tool changer of claim 25, wherein the tool changer comprises a tool loading door configured to selectively close or open the tool loading opening.

44. The tool changer of claim 32, wherein the tool gripper is at least one of:
pivotable about a vertical gripper pivot axis or about a horizontal gripper pivot axis, and
linearly displaceable along a horizontal gripper displacement direction.

45. The tool changer of claim 37, wherein the auxiliary arm is lockable to the pivot arm in a rest position to prevent a pivoting movement of the auxiliary arm about the auxiliary pivot axis.

46. The machine tool of claim 40, wherein the tool spindle is pivotably arranged in the machine tool such that it can be brought into a position in which the tool axis extends vertically in space.
